(19) United States
(12) Patent Application Publication
(10) Pub. No.: US 2014/0338799 A1
(43) Pub. Date: Nov. 20, 2014

(54) EUTECTIC FUEL CELL

(71) Applicants: Ashok Chaudhari, Briarcliff Manor, NY (US); Karin Chaudhari, Briarcliff Manor, NY (US); Pia Chaudhari, Briarcliff Manor, NY (US)

(72) Inventor: Praveen Chaudhari, (US)

(73) Assignee: Solar-Tectic, LLC, Briarcliff Manor, NY (US)

(21) Appl. No.: 14/450,853

(22) Filed: Aug. 4, 2014

Related U.S. Application Data
(60) Provisional application No. 61/892,117, filed on Oct. 17, 2013.

(51) Int. Cl. H01M 4/88; H01M 4/90

(52) U.S. Cl. CPC H01M 4/8882; H01M 4/9041; H01M 4/8825
USPC 148/537; 427/115

(57) ABSTRACT

Eutectic fuel cells are prepared by depositing a metal-semiconductor eutectic alloy over non-platinum electrodes on a substrate. In some embodiments the electrodes are the same metal and in other cases the electrodes are dissimilar.

### PRIORITY AND RELATED APPLICATION

This application claims priority to U.S. Provisional Patent Application Ser. No. 61/892,117, filed Oct. 17, 2013 entitled “Eutectic Fuel Cell,” which is hereby incorporated by reference in its entirety.

### FIELD OF THE INVENTION

The present invention relates to producing inexpensive and more efficient fuel cells.

### BACKGROUND OF THE INVENTION

Fuel cells are an important enabling technology for the nation's energy portfolio and have the potential to revolutionize the way we power our nation, offering cleaner, more-efficient alternatives to the combustion of gasoline and other fossil fuels. Fuel cells have the potential to replace the internal-combustion engine in vehicles and provide power in stationary and portable power applications because they are energy-efficient, clean, and fuel-flexible.

A fuel cell is a device that uses a fuel and oxygen to create electricity by an electrochemical process. A single fuel cell consists of an electrolyte and two catalyst-coated electrodes (a porous anode and cathode). Each of the electrodes is coated on one side with a catalyst layer that speeds up the reaction of oxygen and hydrogen. It is usually made of platinum powder very thinly coated onto carbon paper or cloth. The catalyst is rough and porous so the maximum surface area of the platinum can be exposed to the hydrogen or oxygen. Platinum-group metals are critical to catalyzing reactions in the fuel cell, but they are very expensive. The U.S. Department of Energy's goal is to reduce the use of platinum in fuel cell cathodes by at least a factor of 20 or eliminate it altogether to decrease the cost of fuel cells to consumers.

It is an object of the present invention to provide electrodes for fuel cells that are made of non-platinum material, such as Au, Ni, Al, etc. It is yet another object of this invention to provide a method for growing a thin film between the non-platinum electrodes, consisting of Si, Ge, etc., using eutectics.

### BRIEF SUMMARY OF THE INVENTION

The present invention provides fuel cells created on non-platinum electrodes. In one example the invention grows thin semiconductor films such as silicon between non-platinum electrodes such as gold.

### BRIEF DESCRIPTION OF THE DRAWING

FIG. 1A shows a substrate and electrodes.

FIG. 1B shows a metal-semiconductor film disposed on the substrate and electrodes.

FIG. 1C shows the film on the substrate and electrodes.

FIG. 2A shows a substrate with dissimilar electrodes.

FIG. 2B shows a substrate with dissimilar electrodes and Si—Au eutectic alloy film between them.

### DETAILED DESCRIPTION OF THE INVENTION

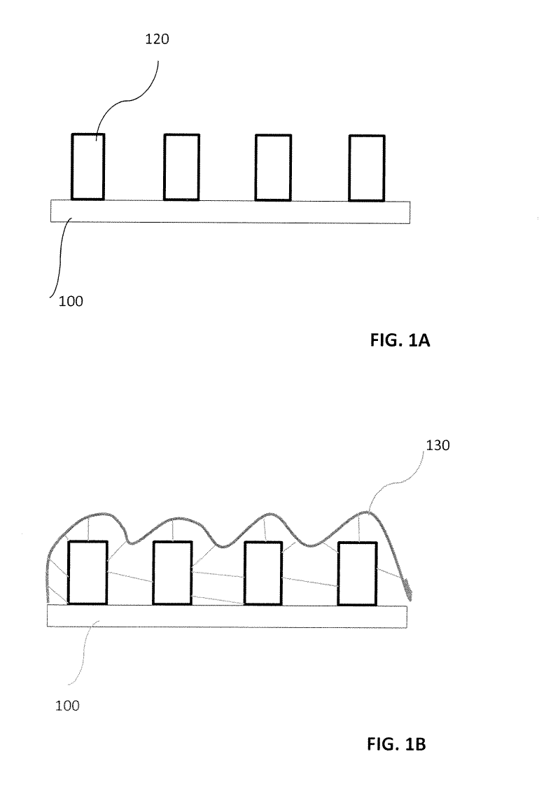

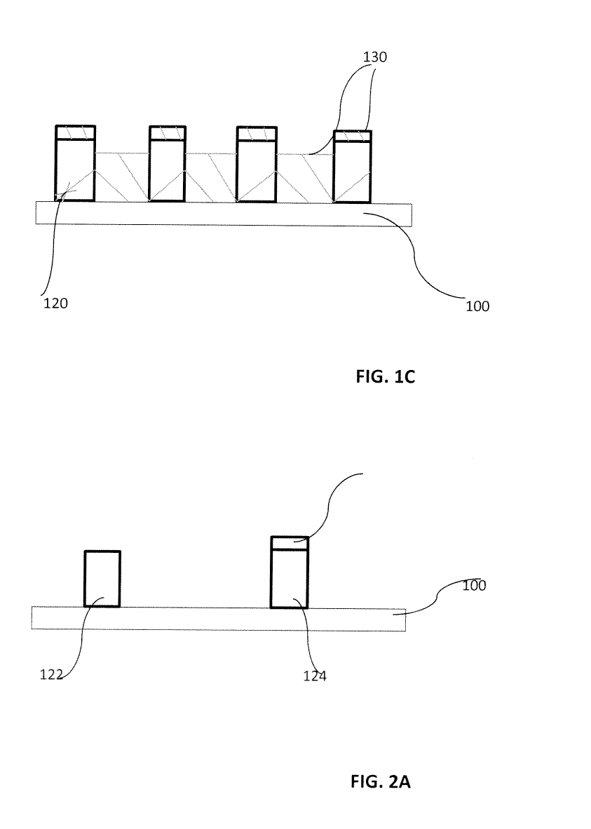

FIGS. 1A-C show an embodiment of creating an improved eutectic fuel cell. Here a thin semiconductor film 130 such as silicon is produced between non-platinum electrodes 120 such as gold on a substrate 110. In order to do this, an Au—Si thin film 130 is deposited over the gold electrodes 120. The substrate 100, electrodes 120 and film 130 are then heated to a eutectic temperature (Te) thus causing the Si to become enlarged.

In another embodiment, amorphous silicon can be deposited between the gold pads with amorphous to crystalline transformation taking place to produce a polycrystalline film of silicon. The film of Si will have grain boundary (gb) perpendicular to the gold pads.

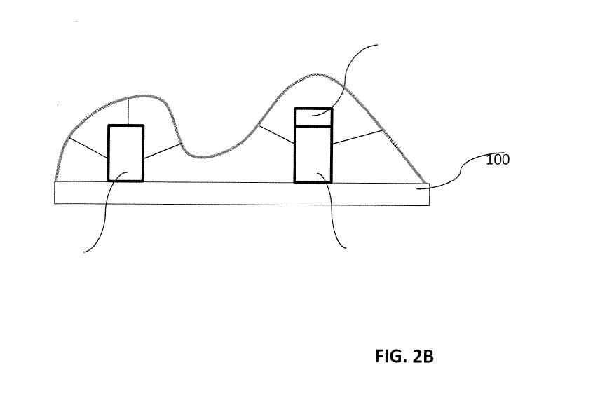

Now looking at FIG. 2 another embodiment is shown where dissimilar metals are used in order to have different temperature/and or different metal-semiconductor contact. In this case, crystallization starts at the Au—Si interface and proceeds to the other electrode. This ensures that the crystallization proceeds from one electrode only.

In another embodiment, Au is deposited on Ag and as Ag diffuses through Au the Si—Au eutectic will change from 363° C. towards 835° C. which will precipitate Si out at a rate determined by diffusion of Au through the Au film. A slow way of crystallizing Si and subsequently Si can be processed at a higher temperature.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A method of creating a eutectic fuel cell comprising:
providing a substrate having a non-platinum electrodes;
depositing a metal-semiconductor eutectic alloy on the electrodes and the substrate;
heating the metal-semiconductor eutectic alloy, the electrodes and the substrate to a eutectic temperature,
wherein a thin semiconductor film is grown between the electrodes.

2. The method of claim 1, wherein the metal-semiconductor eutectic alloy is Au—Si.

3. The method of claim 2, wherein the thin semiconductor film becomes enlarged.

4. The method of claim 1, wherein the electrodes are Au.

5. The method of claim 1, wherein said metal-semiconductor eutectic alloy is heated to the eutectic temperature of said alloy.

6. The method of claim 1, wherein the electrodes are dissimilar metals having different temperatures.

7. The method of claim 1, wherein the electrodes are dissimilar metals having different metal-semiconductor contact.

8. The method of claim 1, wherein crystallization occurs at one metal electrode at a time.

9. A method of creating a eutectic fuel cell comprising:
providing a substrate having electrodes;
depositing an amorphous Si film between the electrodes on the substrate;
heating the substrate and electrodes causing an amorphous to crystalline transformation on said amorphous Si film,
wherein said amorphous Si film will have grain boundary perpendicular to the electrodes.

10. The method of claim 9, wherein the electrodes are Au.

11. The method of claim 9, wherein the electrodes are dissimilar metals having different temperatures.

12. The method of claim 9, wherein the electrodes are dissimilar metals having different metal-semiconductor contact.

13. The method of claim 9, wherein crystallization occurs at one metal electrode at a time.

14. A method of creating a eutectic fuel cell comprising:
providing a substrate having a first electrode and a second electrode, said first and second electrodes being dissimilar electrodes;
depositing an Si—Au film between the dissimilar electrodes on the substrate;
heating the Si—Au film and the substrate with the dissimilar electrodes to a first eutectic temperature of said first electrode and then a second eutectic temperature of said second electrode;
precipitating the Si at a rate determined by diffusion of the Au through Au film;
crystallizing said Si; and
processing said Si at a temperature higher than the first eutectic temperature.

15. The method of claim 14, wherein the electrodes are dissimilar metals having different temperatures.

16. The method of claim 14, wherein the electrodes are Au and Ag.
